(19) United States
(12) Patent Application Publication
(10) Pub. No.: US 2015/0113507 A1
(43) Pub. Date: Apr. 23, 2015

(54) METHOD FOR AUTOMATIC GROUPING OF INTERLINKED GRAPHICAL CONFIGURATION ELEMENTS AND COMPUTER PROGRAM PRODUCT

(71) Applicant: DISTECH CONTROLS INC., Brossard (CA)

(72) Inventor: Patrice Soucy, Brossard (CA)

(73) Assignee: DISTECH CONTROLS INC., Brossard (CA)

(21) Appl. No.: 14/231,798

(22) Filed: Apr. 1, 2014

Related U.S. Application Data
(60) Provisional application No. 61/892,714, filed on Oct. 18, 2013.

(51) Int. Cl. G06F 9/44

(52) U.S. Cl. CPC G06F 8/38
USPC 717/121

(57) ABSTRACT

The present disclosure relates to a method and computer program product for grouping a plurality of interlinked graphical configuration elements (GCEs) into a resulting graphical functional element (GFE). The method and computer program product receive a selection of the plurality of interlinked GCEs to be grouped. The method and computer program product create the resulting GFE by: identifying inputs and outputs of the plurality of GCEs; identifying from the inputs and outputs root inputs and exiting outputs; generating for each root input/exiting output a root input/exiting output graphical representation identifier in the resulting GFE; generating the resulting GFE including the root input/exiting output graphical representation identifiers; graphically linking the root input/exiting output graphical representation identifiers to corresponding GCEs outside of the plurality of interlinked GCEs; and displaying the resulting GFE in replacement of the plurality of interlinked GCEs.

### TECHNICAL FIELD

The present disclosure relates to a method for automatic grouping of interlinked graphical configuration elements and to a corresponding computer program product.

### BACKGROUND

Configuration computer programs are used to assist developers and integrators in configuring components and programs executed by the components. Typically, in the field of industrial environment control, tens and sometimes hundreds of configuration elements are used to configure the various components which control the environment. The configuration elements are usually displayed on a user interface, such as a screen. Each configuration element receives input(s) from other configuration element(s) and/or transmits output(s) to other configuration elements(s). Some configuration elements may only receive inputs or transmit outputs. Other configuration elements are also configured with a program for processing received input(s) to generate transmitted output(s).

Systems for controlling environmental conditions, for example in buildings or factories, are becoming increasingly sophisticated. A control system may at once control heating and cooling, monitor air quality, detect hazardous conditions such as fire, carbon monoxide release, intrusion, and the like. Such control systems generally include at least one environment controller, which receives measured environmental values, generally from external sensors, and in turn determines set-points or command parameters to be sent to controlled appliances.

An environment controller is an example of a component which can be configured with a configuration computer program. Several configuration elements are selected, among a library of available configuration elements, to configure the environment controller. Some configuration elements pre-process measured environmental values (received from sensors) to generate normalized values. Other configuration elements further process the normalized values to determine environmental states, evaluate if some pre-defined environmental conditions are met, etc. Some configuration elements generate command parameters (transmitted to controlled appliances) based on the environmental states and pre-defined conditions.

The various configuration elements which constitute the environment controller are displayed on the user interface by the configuration computer program. Additional configuration elements of other components (such as sensors and controlled appliances) may also be displayed on the user interface. For a user of the configuration program, there may be too many information present on the user interface and too many details, to efficiently use the configuration computer program. Once a set of inter-related configuration elements have been configured and displayed, it may be practical to automatically generate and display a functional element which implements the functionalities of the set of inter-related configuration elements. The functional element constitutes an abstraction layer, which hides details of several configuration elements to the user, reduces the number of elements represented on the user interface, and generally simplifies the configuration of a complete environment control system.

There is therefore a need for a method and computer program product for automatically grouping a plurality of interlinked graphical configuration elements into a resulting graphical functional element.

### SUMMARY

In accordance with a first aspect, the present disclosure relates to a method for grouping a plurality of interlinked graphical configuration elements into a resulting graphical functional element. The method comprises receiving by a processor a selection of the plurality of interlinked graphical configuration elements to be grouped. The method then comprises creating by the processor the resulting graphical functional element. The creation of the resulting graphical functional element comprises identifying by the processor inputs of the plurality of graphical configuration elements; identifying from the inputs of the plurality of graphical configuration elements root inputs by the processor; and generating by the processor for each root input a root input graphical representation identifier in the resulting graphical functional element. The creation of the resulting graphical functional element also comprises identifying by the processor outputs of the plurality of graphical configuration elements; identifying from the outputs of the plurality of graphical configuration elements exiting outputs by the processor; and generating by the processor for each exiting output an exiting output graphical representation identifier in the resulting graphical functional element. The creation of the resulting graphical functional element further comprises generating by the processor the resulting graphical functional element including the root input graphical representation identifiers and the exiting output graphical representation identifiers; graphically linking the root input graphical representation identifiers and exiting output graphical representation identifiers to corresponding graphical configuration elements outside of the plurality of interlinked graphical configuration elements; and displaying the resulting graphical functional element on the graphical interface by the processor in replacement of the plurality of interlinked graphical configuration elements.

In accordance with a second aspect, the present disclosure relates to a computer program product comprising a computer readable memory storing computer executable instructions thereon that when executed by a computer perform the aforementioned method.

### BRIEF DESCRIPTION OF THE DRAWINGS

Embodiments of the disclosure will be described by way of example only with reference to the accompanying drawings, in which:

FIG. 1 illustrates an example of an environment control system;

FIG. 2 illustrates an exemplary environment control device (ECD) used in the environment control system of FIG. 1;

FIG. 3 illustrates a method for grouping a plurality of interlinked graphical configuration elements into a resulting graphical functional element;

FIGS. 4-6 illustrate a graphical interface of a configuration program implementing the method of FIG. 3; and

FIG. 7 illustrates a computer for executing instructions of a configuration program implementing the method of FIG. 3.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to grouping a plurality of interlinked graphical configuration elements into a resulting graphical functional element. For illustration purposes only, the present disclosure specifically addresses graphical configuration elements of components of an environment control system.

### Terminology

The following terminology is used throughout the present disclosure:

Environment: condition(s) (temperature, pressure, oxygen level, light level, security, etc.) prevailing in an area or place, such as for example in a building.

Environment control system: a set of components and devices which interact for monitoring and controlling an environment.

Environmental data: any data (e.g. information, commands) related to an environment that may be exchanged between components of an environment control system.

Environment control device (ECD): generic name for a component of an environment control system. An ECD may consist of an environment controller, a sensor, a controlled appliance, etc.

Environment controller: device capable of receiving information related to an environment and sending commands based on such information.

Environmental characteristic: measurable, quantifiable or verifiable property of an environment.

Environmental characteristic value: numerical, qualitative or verifiable representation of an environmental characteristic.

Sensor: device that detects an environmental characteristic and provides a numerical, quantitative or verifiable representation thereof. The numerical, quantitative or verifiable representation may be sent to an environment controller.

Controlled appliance: device that receives a command and executes the command. The command may be received from an environment controller.

Processing module: processor, computer, or like device or component capable of executing mathematical or logical operations and execute code.

Environmental state: a current condition of an environment based on an environmental characteristic, each environmental state may comprise a range of values or verifiable representation for the corresponding environmental characteristic.

Communication module: device or component capable of providing communication functionalities based on a specific communication technology (for example a standardized or proprietary wired communication technology, or a standardized or proprietary wireless communication technology). A specific protocol or set of protocols corresponding to the specific communication technology is implemented by the communication module.

Wi-Fi: any Wireless Local Area Network (WLAN) product that is based on the Institute of Electrical and Electronics Engineers' (IEEE) 802.11 standards.

Wi-Fi hotspot: communication infrastructure allowing communications between devices using communication protocols based on the 802.11 standards. The hotspot is established by a dedicated device. A device needs to associate with the Wi-Fi hotspot, before being capable of using it for communications with other devices.

### Environmental Control System and Environmental Control Devices

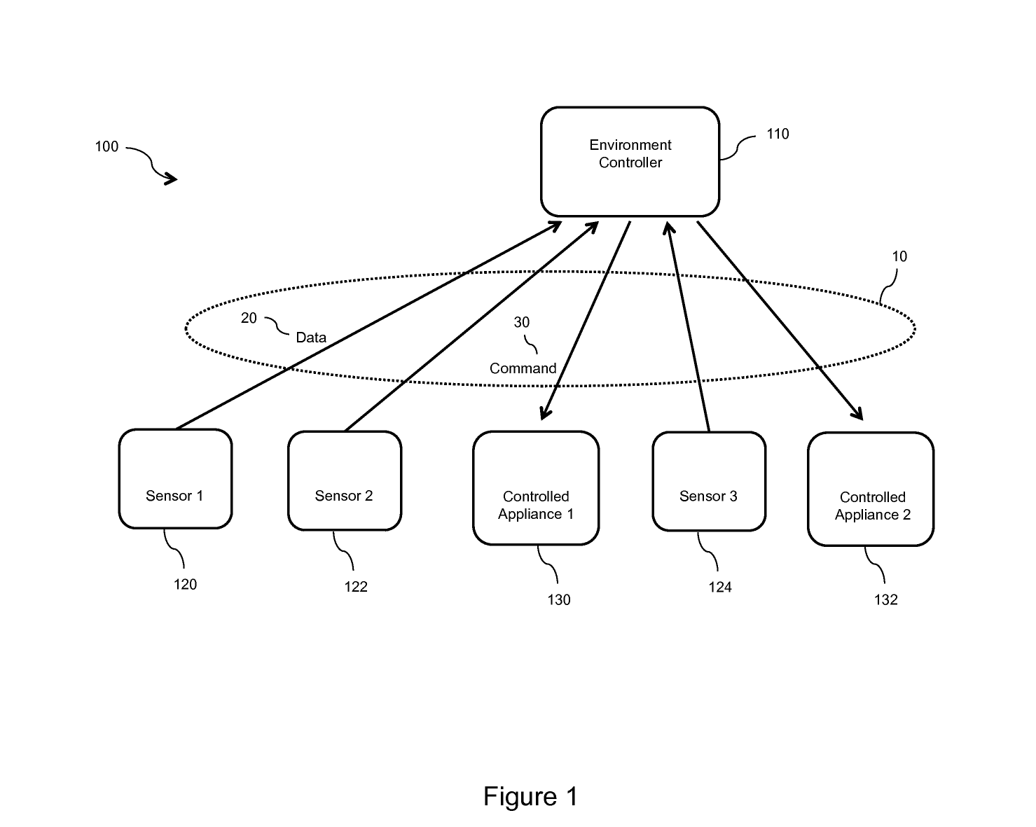

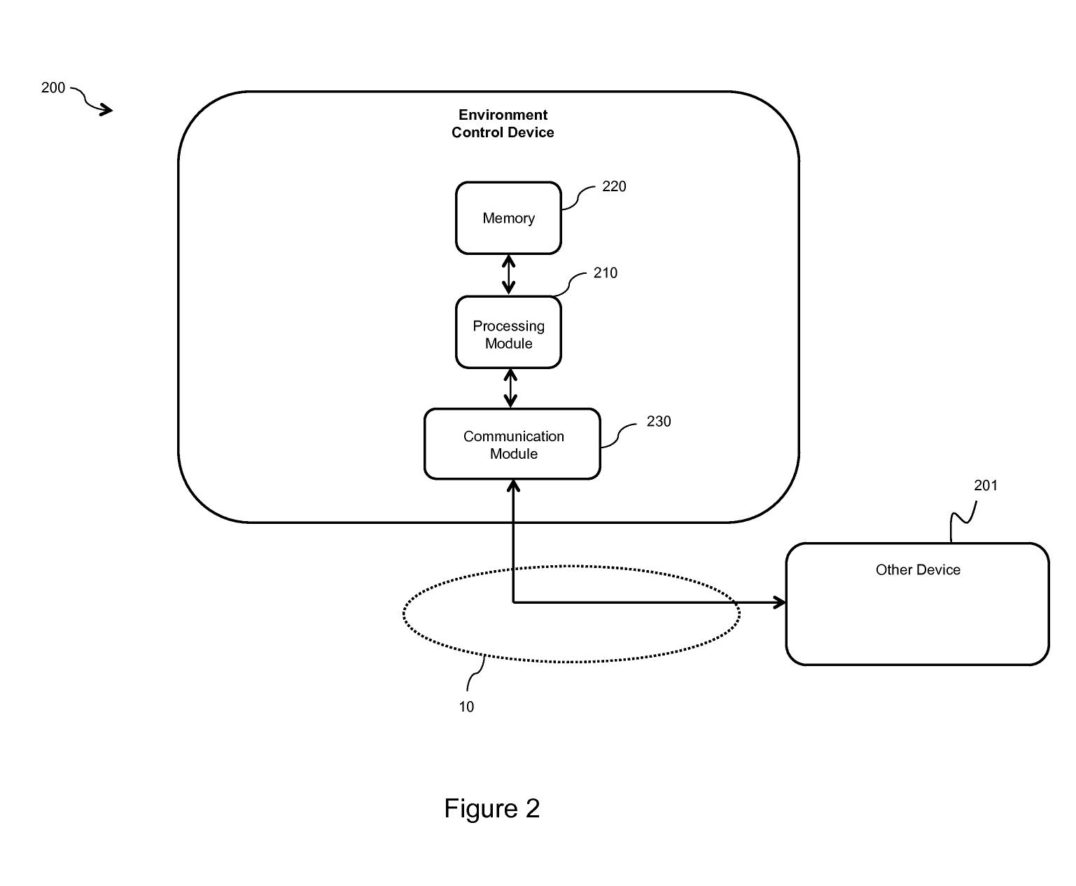

Referring now concurrently to FIGS. 1 and 2, an environment control system 100 comprising several environment control devices (EGDs) 200 is represented. The environment control system 100 is deployed in a controlled area such as a building or a factory (not represented in FIG. 1). The environment control system 100 comprises different types of ECDs 200: an environment controller (110), sensors (120, 122 and 124), and controlled appliances (130 and 132).

All these ECDs 200 exchange information over a communication network 10. The communication network 10 may comprise a wireless communication infrastructure (e.g. one or several Wi-Fi hotspots). Alternatively, the communication network 10 may comprise a wired communication infrastructure (e.g. an Ethernet network). The communication network 10 may also comprise a combination of a wireless communication infrastructure and a wired communication infrastructure.

The sensors (120, 122 and 124) transmit data 20 to the environment controller 110 over the communication network 10. The data 20 generally consist of environmental characteristic values.

The environment controller 110 transmits commands 30 to the controlled appliances (130 and 132) over the communication network 10.

The ECD 200 comprises a communication module 230 for exchanging information with one or several other devices 201 via the communication network 10. The other device 201 generally consists of another ECD. The information exchanged consists of environmental characteristic values (transmitted from a sensor to an environment controller) or commands (transmitted from an environment controller to a controlled appliance).

The ECD 200 also comprises a processing module 210, for processing information received via the communication module 230 from another device 201 and/or for generating information transmitted via the communication module 230 to another device 201. In the case of the environment controller 110, the processing module 210 receives environmental characteristic values 20 transmitted by the sensors (120, 122 and 124), processes these values, and generates commands 30 transmitted to the controlled appliances (130 and 132).

The ECD 200 also comprises a memory 220. The memory 220 is capable of storing environmental characteristic values received via the communication module 230. The memory 220 is also capable of storing data (e.g. environmental states) which result from the processing by the processing module 210 of environmental characteristic values received via the communication module 230.

The processing module 210 of the environment controller 110 executes instructions of a dedicated computer program to process the environmental characteristic values received via the communication module 230, to generate data such as environmental states stored in the memory 220, and to generate commands transmitted via the communication module 230. For instance, the dedicated computer program may transform temperature values received from a temperature sensor and expressed in Fahrenheit, into temperature values expressed in Celsius. Additionally, the dedicated computer program may compare temperature and humidity values received from temperature and humidity sensors with respective thresholds, and generate a command to be sent to a controlled air conditioner based on the result of the comparison.

### Configuration Program for Configuring and Displaying Graphical Configuration Elements of a Components

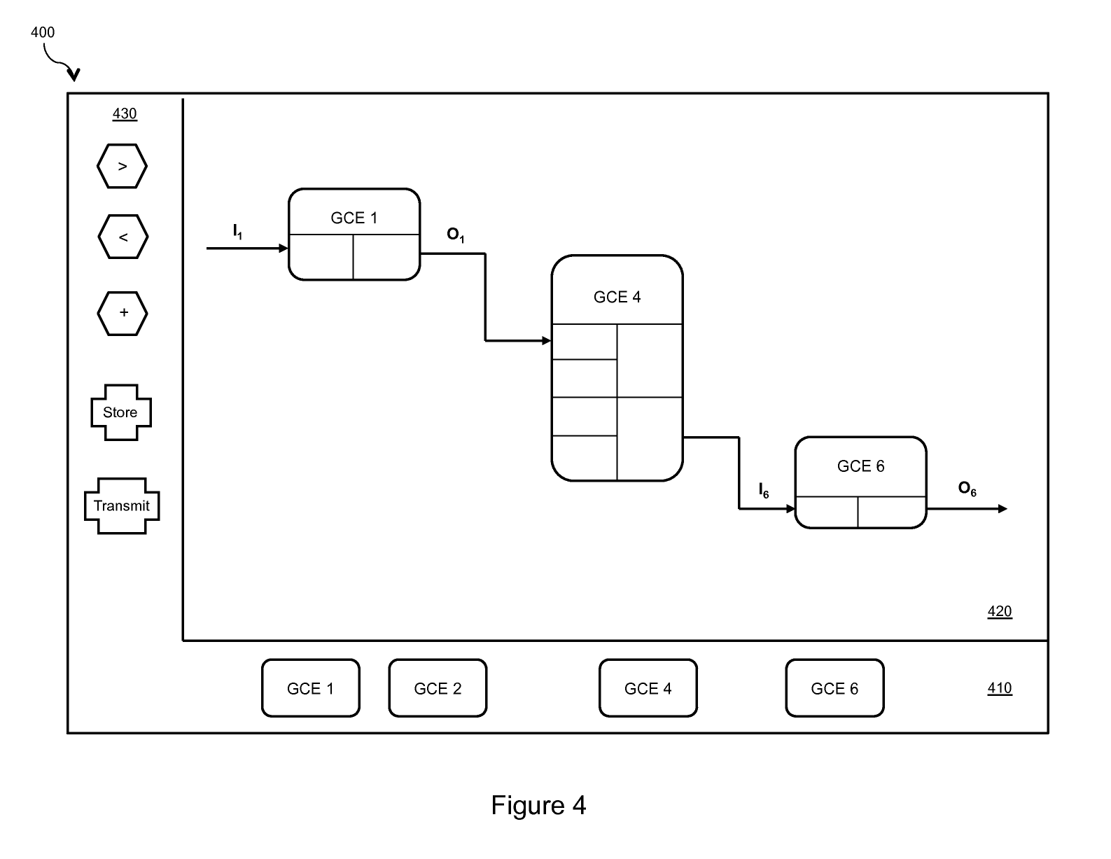

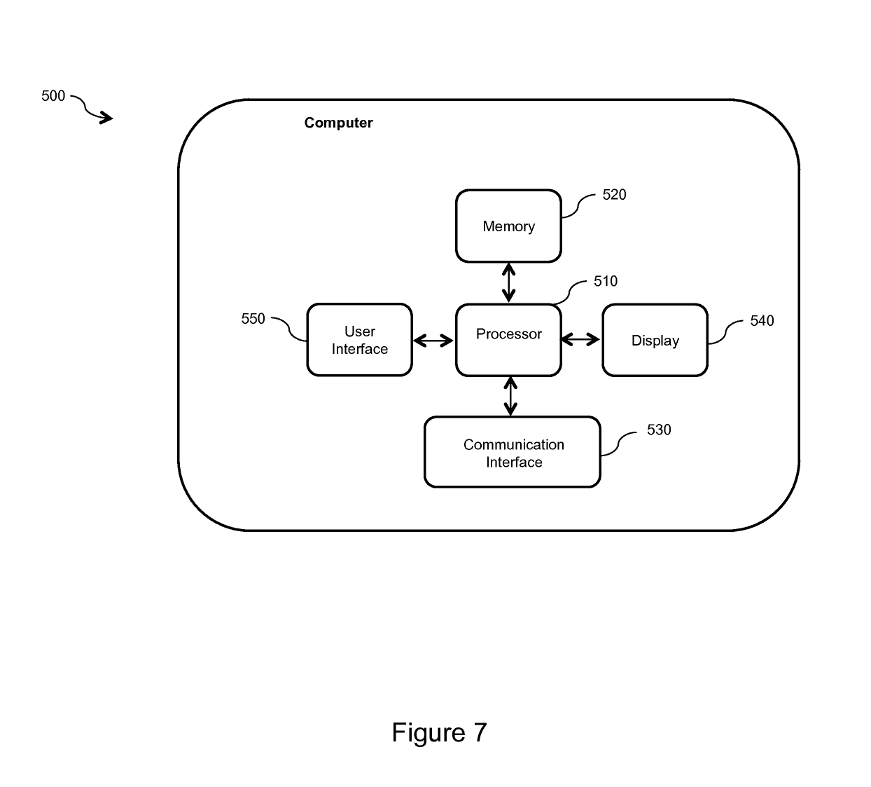

Referring now concurrently to FIGS. 4 and 7, a graphical interface 400 of a configuration program for configuring and displaying graphical configuration elements of a component and a computer 500 are represented.

The configuration program configures and displays on the graphical interface 400 graphical configuration elements (GCEs) of one or several components. The configuration program is executed by a processor 510 of the computer 500. The computer 500 also comprises a display 540 (e.g. a regular screen or a touchscreen) for displaying the graphical interface 400. The computer 500 further comprises a user interface 550 (e.g. a mouse, a keyboard, a touchscreen) for allowing a user to interact with the configuration program.

In a particular embodiment, the configuration program is adapted for configuring components of the environment control system 100 represented in FIG. 1. Thus, the components comprise the environment controller 110, sensors (120, 122 and 124) and controlled appliances (130 and 132) represented in FIG. 1.

The graphical interface 400 comprises a region 410 where several types of GCEs are represented. For simplification purposes, only four types have been represented in FIG. 4: GCE 1, GCE 2, GCE 4 and GCE 6. A user selects via the user interface 550 a specific type of GCE among those available in the region 410. An instance of the selected GCE is displayed in a region 420. The user determines via the user interface 550 the position of the displayed GCE in the region 420.

FIG. 4 illustrates a case where three types of GCEs (GCE 1, GCE 4 and GCE 6) have been selected in the region 410 and displayed in the region 420. Each type of GCE may have 0, 1 or more inputs. Each type of GCE may have 0, 1 or more outputs. Each type of GCE may perform a specific processing on its input(s) to generate its output(s). For illustration purposes, GCE 1 receives one input I₁ and generates one output O₁. GCE 4 receives four inputs and generates two outputs. GCE 6 receives one input I₆ and generates one output O₆. The GCEs have been positioned in region 420 and interconnected in such a manner that the output O₁ of GCE 1 is an input of GCE 4 and the input I₆ of GCE 6 is an output of GCE 4. The interconnection of the GCEs is out of the scope of the present disclosure and may be implemented by an interaction of the user with the graphical interface 400 via the user interface 550.

The configuration program automatically generates a dedicated computer program for the component, based on the GCEs that have been used to configure the component. Each type of GCE implements a specific sub-program, which processes its inputs and generates its outputs according to a specific functionality of the GCE. The integration of the various sub-programs of the GCEs generates the dedicated computer program of the component. The graphical interface 400 may comprise an additional region 430 with resources for customizing the functionalities of the GCEs, for instance to adapt the sub-programs executed by the GCEs.

For illustration purposes, GCE 1, GCE 4 and GCE 6 represented in FIG. 4 may be GCEs of an environment controller. GCE 1 may transform temperature values received (I₁) from a temperature sensor (not represented in FIG. 4) and expressed in Fahrenheit, into temperature values expressed in Celsius, which are further transmitted (O₁) to GCE 4. GCE 4 may compare the received temperature value (O₁) with a configurable temperature threshold, and transmit a generic command (I₆) to GCE 6 when the threshold is reached. GCE 6 may transform the generic command (I₆) into a dedicated command (O₆), transmitted to a specific type of controlled appliance (not represented in FIG. 4).

Method for Grouping a Plurality of Interlinked Graphical Configuration Elements into a Resulting Graphical Functional Element

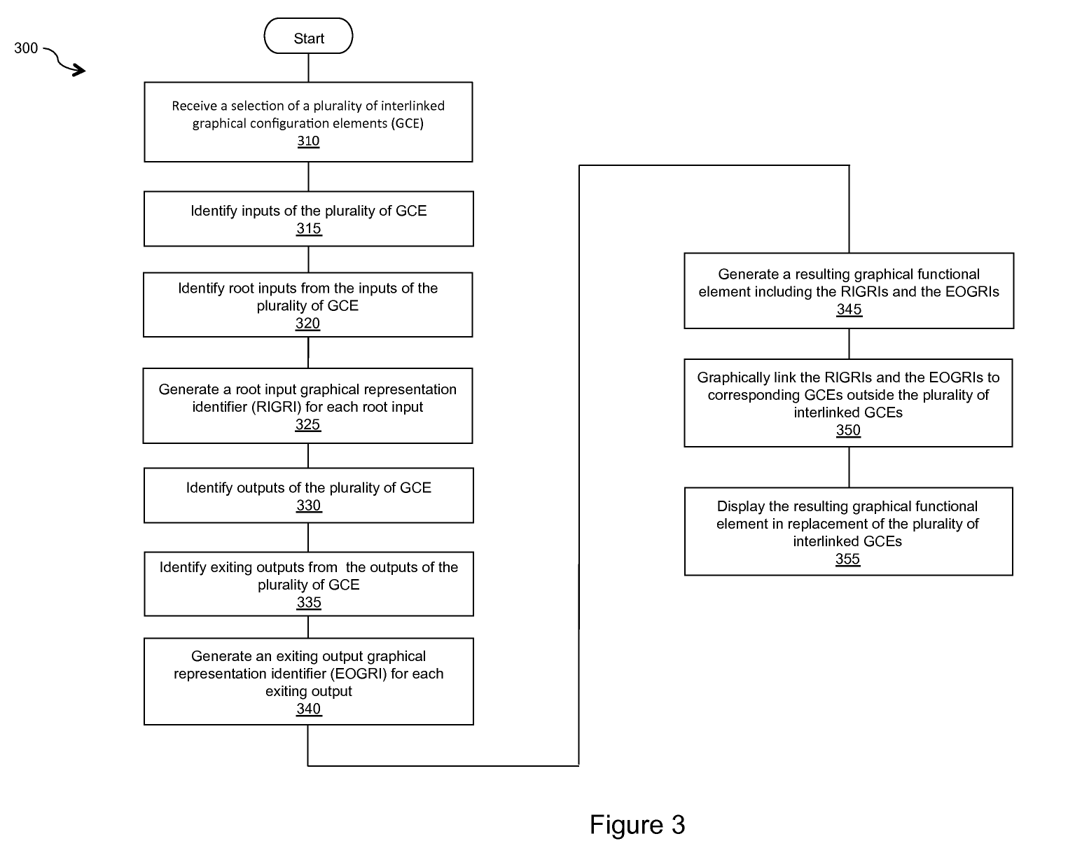

Referring now concurrently to FIGS. 3-7, a method 300 for grouping a plurality of interlinked graphical configuration elements (GCEs) into a resulting graphical functional element and the graphical interface 400 are represented.

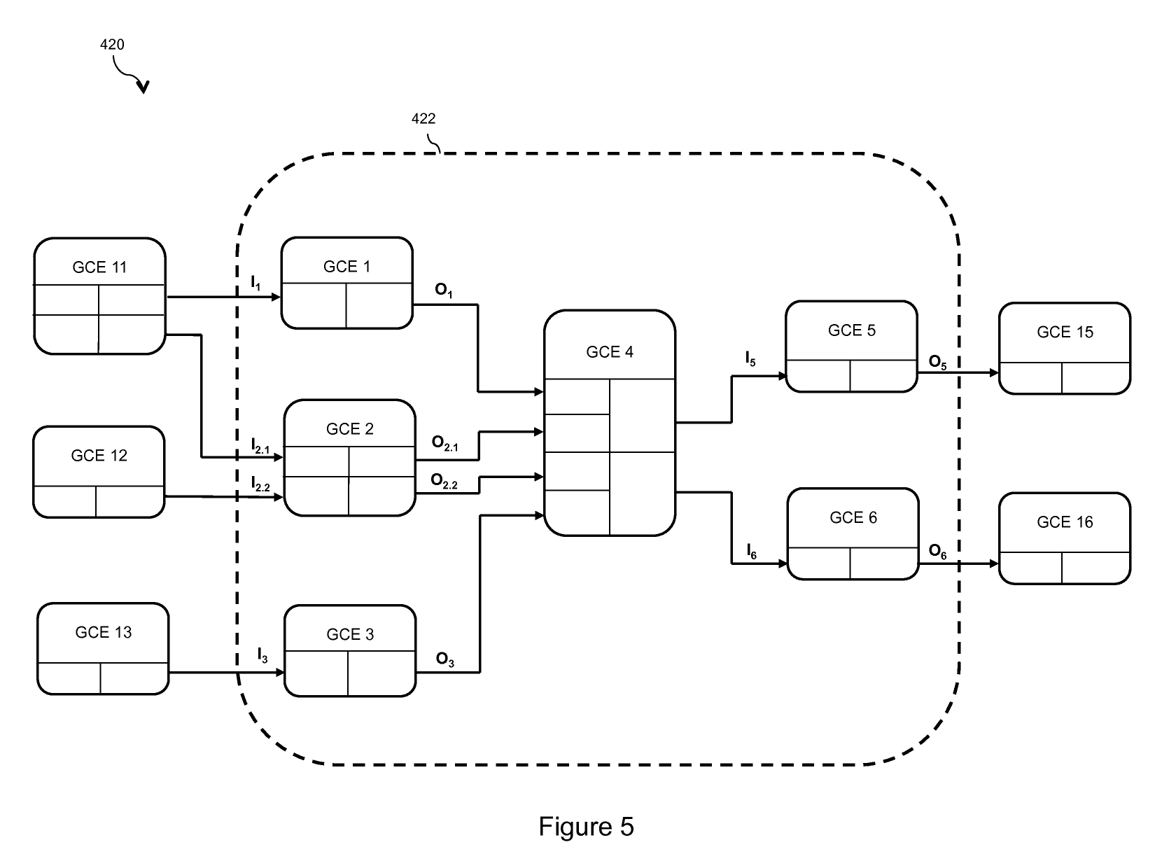

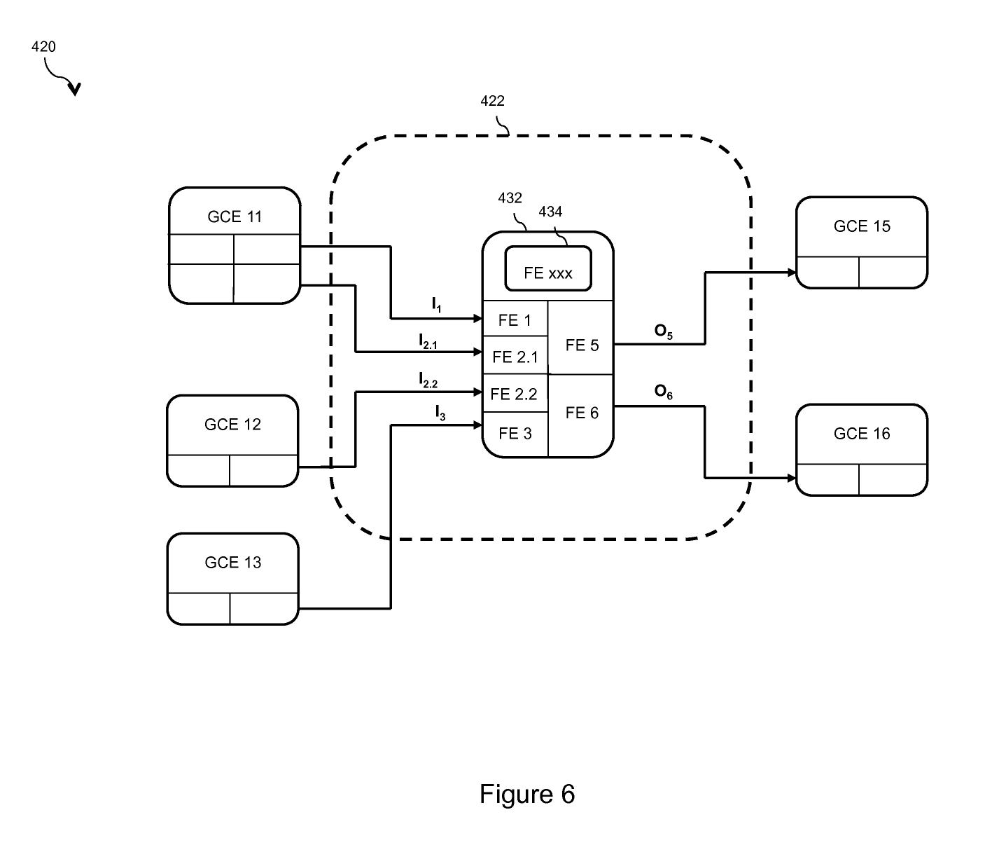

FIG. 5 represents a plurality of interlinked GCEs (GCE1, GCE 2, GCE 3, GCE 4, GCE 5, GCE 6, GCE 11, GCE 12, GCE 13, GCE 15 and GCE 16) displayed in the region 420 of the graphical interface 400. For simplification purposes, only the region 420 of the graphical interface 400 is represented in FIGS. 5 and 6.

GCE 1 receives one input I₁ from GCE 11 and generates one output O₁ transmitted to GCE 4. GCE 2 receives one input I_{2.1} from GCE 11 and one input I_{2.2} from GCE 12. GCE 2 generates two outputs O_{2.1} and O_{2.2} transmitted to GCE 4. GCE 3 receives one input I₃ from GCE 13 and generates one output O₃ transmitted to GCE 4. GCE 5 receives one input I₅ from GCE 4 and generates one output O₅ transmitted to GCE 15. GCE 6 receives one input O₆ from GCE 4 and generates one output O₆ transmitted to GCE 16. The combination of interlinked GCE 1, GCE 2, GCE 3, GCE 4, GCE 5 and GCE 6 may be considered as an integrated functional element comprising a central processing unit (GCE 4), several pre-processing units (GCE 1, GCE 2 and GCE 3) and several post-processing units (GCE 5 and GCE 6).

The method 300 comprises receiving 310 by the processor 510 a selection of a plurality of interlinked GCEs to be grouped. For example, with reference to FIG. 5, the selection of the plurality of interlinked GCEs to be grouped consists in GCE 1, GCE 2, GCE 3, GCE 4, GCE 5 and GCE 6. The selection may be performed by the user, via the user interface 550. For instance, the user may use a mouse to select a zone 422 in the region 420 comprising the selected GCEs. Alternatively, the selection may be automatically performed by the processor 510 via a dedicated selection algorithm (using specific selection criteria), which is out of the scope of the present disclosure.

The method 300 further comprises creating by the processor 510 a resulting graphical functional element 432 represented in FIG. 6. For this purpose, the method 300 comprises the following steps.

The method 300 comprises identifying 315 by the processor 510 inputs of the plurality of selected GCEs. For example, with reference to FIG. 5, the identified inputs consist in I₁ for GCE 1; I_{2.1} and I_{2.2} for GCE 2; I₃ for GCE 3; O₁, O_{2.1}, O_{2.2} and O₃ for GCE 4; I₅ for GCE 5; and I₆ for GCE 6.

The method 300 comprises identifying 320 from the inputs of the plurality of selected GCEs root inputs by the processor 510. The root inputs consist in inputs received from GCEs outside the graphical functional element 432 (outside zone 422) and exclude inputs exchanged between GCEs within the graphical functional element 432 (within zone 422). For example, with reference to FIG. 5, the identified root inputs consist in I₁ for GCE 1; I_{2.1} and I_{2.2} for GCE 2; and I₃ for GCE 3.

The method 300 comprises generating 325 by the processor 510 for each root input a root input graphical representation identifier in the resulting graphical functional element 432. For example, with reference to FIG. 6, the root input graphical representation identifiers FE 1, FE 2.1, FE 2.2 and FE 3 respectively correspond to the identified root inputs I₁, I_{2.1}, I_{2.2} and I₃.

The method 300 also comprises identifying 330 by the processor 510 outputs of the plurality of selected GCEs. For example, with reference to FIG. 5, the identified outputs consist in O₁ for GCE 1; O_{2.1} and O_{2.2} for GCE 2; O₃ for GCE 3; I₅ and I₆ for GCE 4; O₅ for GCE 5; and O₆ for GCE 6.

The method 300 comprises identifying 335 from the outputs of the plurality of selected GCEs exiting outputs by the processor 510. The exiting outputs consist in outputs transmitted to GCEs outside the graphical functional element 432 (outside zone 422) and exclude outputs exchanged between GCEs within the graphical functional element 432 (within zone 422). For example, with reference to FIG. 5, the identified exiting outputs consist in O₅ for GCE 5 and O₆ for GCE 6.

The method 300 also comprises generating 340 by the processor 510 for each exiting output an exiting output graphical representation identifier in the resulting graphical functional element 432. For example, with reference to FIG. 6, the exiting output graphical representation identifiers FE 5 and FE 6 respectively correspond to the identified exiting outputs O₅ and O₆.

Then, the method 300 comprises generating 345 by the processor 510 the resulting graphical functional element 432, including the root input graphical representation identifiers and the exiting output graphical representation identifiers. For example, with reference to FIG. 6, the resulting graphical functional element 432 comprises the root input (FE 1, FE 2.1, FE 2.2 and FE 3) and the exiting output (FE 5 and FE 6) graphical representation identifiers.

The method 300 also comprises graphically linking 350 the root input graphical representation identifiers and exiting output graphical representation identifiers to corresponding GCEs outside of the plurality of selected interlinked GCEs. For example, with reference to FIG. 6, the root input graphical representation identifiers FE 1, FE 2.1, FE 2.2 and FE 3 are respectively linked to GCE 11, GCE 11, GCE 12 and GCE 13. The exiting output graphical representation identifiers FE 5 and FE 6 are respectively linked to GCE 15 and GCE 16.

Finally, the method 300 comprises displaying 355 the resulting graphical functional element 432 in the region 420 of the graphical interface 400 by the processor 510, in replacement of the plurality of selected interlinked GCEs (GCE 1, GCE 2, GCE 3, GCE 4, GCE 5 and GCE 6).

Steps 310 to 350 of the method 300 may be performed in the background by the processor 510, without displaying these various steps of the generation of the resulting graphical functional element 432 on the graphical interface 400. When the resulting graphical functional element 432 is completely generated, the last step 350 of the method 300 is performed and the plurality of selected interlinked GCE is replaced on the graphical interface 400 by the resulting graphical functional element 432.

Furthermore, although the steps 310 to 355 of the method 300 have been described in a particular order, they may be performed in a different order. For example, steps 315, 320 and 325 may be performed after steps 330, 335 and 340. Also, the actions in steps 345 and 350 related to the root inputs may be grouped with corresponding steps 315, 320 and 325; while the actions in steps 345 and 350 related to the exiting outputs may be grouped with corresponding steps 330, 335 and 340.

The method 300 may also comprise an additional step consisting in generating an entry field 434 for allowing the user to type a name (e.g. “FE xxx” as illustrated in FIG. 6) for the resulting graphical functional element 432.

Computer Program Product for Grouping a Plurality of Interlinked Graphical Configuration Elements into a Resulting Graphical Functional Elements

Referring now concurrently to FIGS. 3 and 7, the computer 500 comprises a computer readable memory 520.

A computer program product comprising the computer readable memory 520 stores computer executable instructions thereon. When executed by the processor 510 of the computer 500, the computer executable instructions perform the aforementioned method 300 for grouping a plurality of interlinked graphical configuration elements into a resulting graphical functional element.

In an alternative embodiment, the computer program product comprises a computer readable memory located in another computer (not represented in FIG. 7) for storing the computer executable instructions thereon. The computer executable instructions are transmitted from the other computer to the computer 500 over a communication network (not represented in FIG. 7). The computer 500 comprises a communication interface 530 for receiving the computer executable instructions from the other computer. The received computer executable instructions are executed by the processor 510 of the computer 500.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for grouping a plurality of interlinked graphical configuration elements into a resulting graphical functional element, the method comprising:
receiving by a processor a selection of the plurality of interlinked graphical configuration elements to be grouped;
creating by the processor the resulting graphical functional element by:
identifying by the processor inputs of the plurality of graphical configuration elements;
identifying from the inputs of the plurality of graphical configuration elements root inputs by the processor;
generating by the processor for each root input a root input graphical representation identifier in the resulting graphical functional element;
identifying by the processor outputs of the plurality of graphical configuration elements;
identifying from the outputs of the plurality of graphical configuration elements exiting outputs by the processor;
generating by the processor for each exiting output an exiting output graphical representation identifier in the resulting graphical functional element;
generating by the processor the resulting graphical functional element including the root input graphical representation identifiers and the exiting output graphical representation identifiers;
graphically linking the root input graphical representation identifiers and exiting output graphical representation identifiers to corresponding graphical configuration elements outside of the plurality of interlinked graphical configuration elements; and
displaying the resulting graphical functional element on a graphical interface by the processor in replacement of the plurality of interlinked graphical configuration elements.

2. The method of claim 1, wherein the selection is performed by a user.

3. The method of claim 2, wherein the user selects the plurality of graphical configuration elements by means of a mouse.

4. The method of claim 1, wherein creating by the processor the resulting graphical functional element further comprises generating an entry field for allowing the user to type a name for the resulting graphical functional element.

5. A computer program product comprising a computer readable memory storing computer executable instructions thereon that when executed by a computer perform the method of claim 1.
